(19) United States
(12) Patent Application Publication
(10) Pub. No.: US 2024/0239600 A1
(43) Pub. Date: Jul. 18, 2024

(54) METHOD AND APPARATUS FOR WASTE DISPOSAL

(71) Applicant: LACR SOLUTIONS LLC, Medina, OH (US)

(72) Inventor: Ray Hegarty, Medina, OH (US)

(73) Assignee: LACR SOLUTIONS LLC, Medina, OH (US)

(21) Appl. No.: 18/153,477

(22) Filed: Jan. 12, 2023

(51) Int. Cl. B65F 1/08

(52) U.S. Cl. CPC B65F 1/08; B65F 2210/1023; B65F 2240/152; B65F 2250/114

(57) ABSTRACT

Provided in this disclosure is a waste management system including a receptacle having an interior volume for receiving waste liquid. A diffuser unit is configured to be inserted and retained within the interior volume of the receptacle. The diffuser unit includes a top section, a bottom section, and a central column spanning the interior volume of the receptacle and defining a fluid channel between the top section and bottom section of the diffuser unit. A plurality of apertures are formed along surfaces of the top section, the bottom section, and/or the central column, for establishing a fluid connection between the fluid channel and the interior volume of the receptacle for the waste liquid to flow. Solidification components are retained within the interior volume of the receptacle. The solidification components are selected to absorb and neutralize components of the waste liquid into a chemically stable solid.

### I. BACKGROUND

### A. Technical Field

This invention pertains to the field of residential and commercial household hazardous wastes (HHW) and proper disposal.

### B. Description of Related Art

Chemicals are pervasive in modern life, which results in problems associated with disposal of hazardous waste, particularly for ordinary household consumers. One solution is to use solidification products for absorbing hazardous chemicals and chemically retaining them against leakage which could contaminate the soil and water. Many types of solidification products are currently available on the market, including PIG loose absorbent, “Krud Kutter” paint hardener and loose absorbent, and even common cat litter.

There are several problems with the current solidification products on the market. For household consumers, there are many different types of hazardous liquids requiring disposal, including gasoline, diesel fuel, windshield washer fluids, lubricating grease, kitchen grease, oil (from lawn mowers, power equipment, automobiles, etc.), latex paint, solvent-based paint, pesticides, cleaners, etc. There are thousands of different household hazardous wastes requiring disposal, as listed at the consumer chemical database https://www.whatsinproducts.com/pages/index/1.

Such many-varied disposal concerns can be quite alarming and overwhelming for consumers and also for product manufacturers. Moreover, each waste stream requires special chemical additives for each type of waste in the stream based on composition. Further, there is no set of guidelines for each type of household hazardous waste in a waste stream. Thus, the consumer must independently determine how to set up a suitable “solidification” mix pit, or operation on how to clean up materials.

The Environmental Protection Agency (EPA) excludes certain solid wastes from the definition of hazardous waste. If a material meets an exclusion from the definition of hazardous waste, it is not regulated as a hazardous waste, even if the material technically meets a listing or exhibits a characteristic that would normally meet this definition. Household Hazardous Waste (HHW) is excluded from the definition of hazardous waste under 40 CFR § 261.4(b)(1). Nonetheless, HHW can still contribute to overall environmental contamination and there remains an interest in establishing and securing such materials against leaking into the soil and water.

There are also many known problems with improper disposal of “garbage juice,” liquids from residential garbage cans containing household hazardous waste and contaminants. Soil and water can become contaminated, and wildlife can be disrupted. Some garbage liquids are flammable, and gasoline, diesel fuel and oils can lead to forest fires if dumped illegally. Such illegal dumping can lead to future brownfield cleanup and expenditure of US tax dollars. Such illegal dumping is punished with civil and criminal fines against garbage hauling companies in accordance with the US Department of Transportation (DOT) and the individual states, which can have regulations at least as stringent or more stringent than federal standards. Nonetheless, such “garbage juice” from residential garbage cans still finds its way into the soil and water despite such legal proscriptions.

Currently HHW liquid waste (i.e., oils, grease, gasoline, paint, pesticides, etc.) poses a problem for waste disposal hauling companies and contractors. Homeowners place HHW liquid waste unwittingly in their garbage, which can create an environmental issue as well as a safety and DOT issue when liquids spill out as “garbage juice” from the back of garbage trucks causing potential environmental damages, spillage to water ways and/or immediate traffic collisions/accidents.

### II. SUMMARY

Provided in this disclosure is a waste management system including a receptacle having an interior volume for receiving waste liquid. A diffuser unit is configured to be inserted and retained within the interior volume of the receptacle. The diffuser unit includes a top section received and retained proximate to a top surface of the interior volume of the receptacle. The diffuser unit also includes a bottom section received and retained proximate to a bottom surface of the interior volume of the receptacle. The diffuser unit also includes a central column spanning the interior volume of the receptacle and defining a fluid channel between the top section and bottom section of the diffuser unit. A plurality of apertures are formed along one or more surfaces of one or more of the top section, the bottom section, and the central column, for establishing a fluid connection between the fluid channel and the interior volume of the receptacle for the waste liquid to flow. One or more solidification components are retained within the interior volume of the receptacle. The solidification component(s) are selected to absorb and neutralize one or more components of the waste liquid into a chemically stable solid.

In the present waste management system, the receptacle has a cylindrical shape and wherein the top and bottom sections each have a circular perimeter that fits within the cylindrical shape of the receptacle. The top and bottom sections include side walls extending away from the circular perimeter to respectively rest against the top and bottom surfaces to each define a fluid volume connected to the flow channel. Some or all of the plurality of apertures are formed onto the top and bottom sections as part of the fluid connection. Some or all of the plurality of apertures are formed along the side walls as part of the fluid connection. Some or all of the plurality of apertures are formed onto the central column as part of the fluid connection.

In the present waste management system, the diffuser unit is formed of a material chemically compatible to the solidification component(s). The diffuser unit and the solidification component(s) are both formed of a combustible material. The solidification component(s) can include a plurality of solidification components corresponding to a respective plurality of components of the waste liquid.

Provided also in this disclosure is a waste management process, including a step of providing a receptacle having an interior volume for receiving waste liquid. Another step is performed of inserting and retaining a diffuser unit within the interior volume of the receptacle, where the diffuser unit includes a top section received and retained proximate to a top surface of the interior volume of the receptacle, a bottom section received and retained proximate to a bottom surface of the interior volume of the receptacle, and a central column spanning the interior volume of the receptacle and defining a fluid channel between the top section and bottom section. An additional step is performed of selecting one or more solidification components to absorb and neutralize one or more components of the waste liquid into a chemically stable solid. A further step is performed of adding the solidification component(s) to the interior volume of the receptacle. Another further step is performed of flowing the waste liquid into the fluid channel and through a fluid connection established between the fluid channel and the interior volume of the receptacle through a plurality of apertures formed along one or more surfaces of one or more of the top section, the bottom section, and the central column so that the waste liquid is absorbed and neutralized into the chemically stable solid by the solidification component(s).

The present waste management process also includes a step of shredding the receptacle, the diffuser unit, and the chemically stable solid into a disposable material. The receptacle, the diffuser unit and the chemically stable solid can be of combustible materials, so that another step can include burning the receptacle, the diffuser unit, and the chemically stable solid in a combustion process. A plurality of solidification components can be added to absorb and neutralize a corresponding respective plurality of components of the waste liquid. A step can be performed of shipping the receptacle, the diffuser unit, and the chemically stable solid to a receiver location for subsequent disposal. An additional step can include adding one or more additives to the solidification component(s) to render the chemically stable solid into a soil suitable for growing a plant product.

According to an aspect of the invention, a household hazardous waste is simplified for homeowners, particularly US residents.

According to another aspect of the invention, each type of household hazardous waste can be identified and treated, facilitating waste management.

According to still another aspect of the invention, guidelines and best management practices can be provided for each individual waste stream.

According to yet another aspect of the invention, current mechanisms for managing household hazardous waste are rendered obsolete.

According to a further aspect of the invention, soil and groundwater contamination is reduced.

According to another further aspect of the invention, wildlife loss is reduced.

According to still another further aspect of the invention, natural disasters and forest fires due to illegal dumping are reduced.

According to yet another further aspect of the invention, future taxpayer burden and costs are reduced from the reduction of brownfield cleanups.

Other benefits and advantages of this invention will become apparent to those skilled in the art to which it pertains upon reading and understanding of the following detailed specification.

### III. BRIEF DESCRIPTION OF THE DRAWINGS

The disclosed waste management system and method may take physical form in certain parts and arrangement of parts, embodiments of which will be described in detail in this specification and illustrated in the accompanying drawings which form a part hereof and wherein:

FIG. 1 is a perspective phantom view depicting a waste management system including a diffuser unit inserted and retained within a 1-gallon bucket in accordance with the present invention.

FIG. 2 is a perspective view of a middle column of a diffuser unit for a waste management system in accordance with the present invention.

FIGS. 3A and 3B are respectively a perspective exploded view of the components in the diffuser unit, and a bottom section of a diffuser unit for a waste management system in accordance with the present invention.

FIGS. 4A, 4B, 4C, 4D, 4E, 4F, 4G, 4H, 4I, 4J, 4K, 4L, 4M, 4N, 4O, 4P, 4Q, 4R, 4S, 4T, 4U, 4V, 4W, 4X, 4Y, and 4Z respectively depict ¼ pint, ½ pint, 1 pint, 1 quart, 0.6 gallon, 1 gallon, 1.25 gallon, 2 gallon round, 2.5 gallon round, 2 gallon square, 3.5 gallon, 4 gallon square, 5 gallon round, 5 gallon square, 6 gallon, 6.5 gallon, 7 gallon, 10 gallon, 12 gallon, 14 gallon, 15 gallon, 16 gallon, 30 gallon, 55 gallon, 275 gallon and 330 gallon receptacles into which respective diffuser units can be employed in accordance with the present invention.

### IV. DETAILED DESCRIPTION

Reference is now made to the drawings wherein the showings are for purposes of illustrating embodiments of the article only and not for purposes of limiting the same, and wherein like reference numerals are understood to refer to like components.

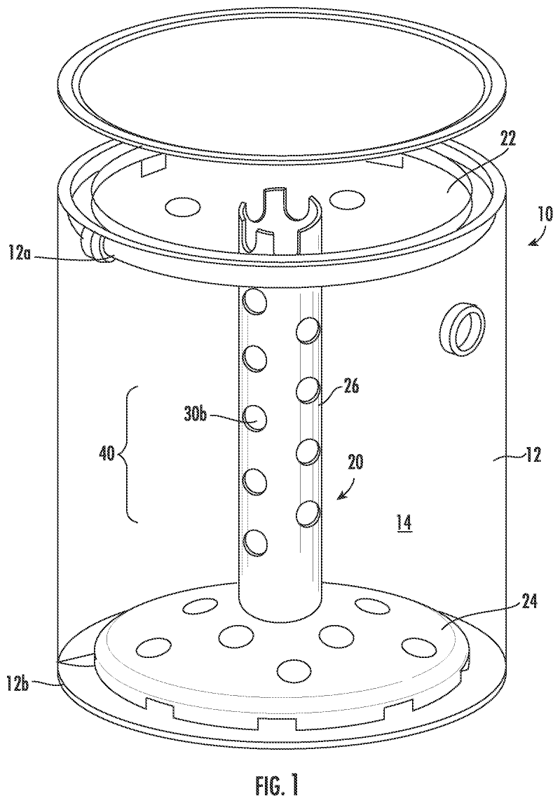

FIG. 1 shows a waste management system 10 including a receptacle 12 (shown in phantom) having an interior volume 14 for receiving a waste liquid. A diffuser unit 20 is configured to be inserted and retained within the interior volume 14 of the receptacle 12. The diffuser unit 20 includes a top section 22 that is received and retained proximate to a top surface 12b of the receptacle 12 within the interior volume 14. The diffuser unit 20 also includes a bottom section 24 received and retained proximate to a bottom surface 12b of the receptacle 12 within the interior volume 14. The diffuser unit 20 further includes a central column 26 which connects the top and bottom sections 22, 24 and spanning the interior volume 14 of the receptacle 12 between the top surface 12a and the bottom surface 12b and defining a fluid channel between the top section 22 and the bottom section 24 of the diffuser unit 20.

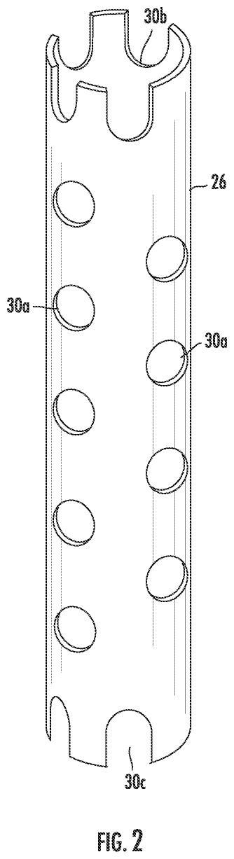

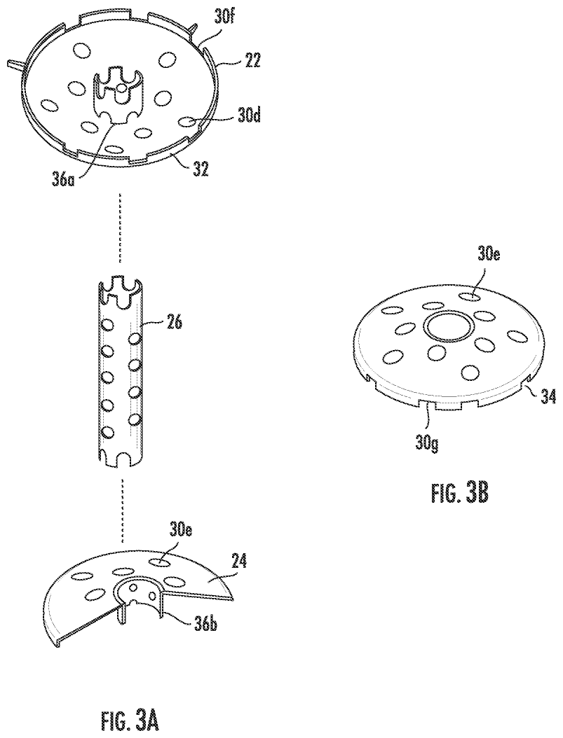

With continued reference to FIG. 1 and additionally to FIGS. 2, 3A, and 3B, the diffuser unit 20 further includes a plurality of apertures formed along at one or more surfaces of the one or more of the top section 22, the bottom section 24, and the central column 26, for establishing a fluid connection between the fluid channel and the interior volume 14 of the receptacle 12 for the waste liquid to flow. The number of apertures and the size of apertures can be specifically selected according to the size of the diffuser unit 20 and the component(s) of the waste stream, which can vary according to viscosity and other physical and chemical properties.

As shown in FIGS. 1 and 2, the central column 26 can be cylindrical in shape and can have parallel rows of apertures 30a formed along the length of the cylindrical surface. In this way, waste fluid can flow from the fluid passage within the central column 26 and into the interior volume 14. The central column 26 can also include apertures 30b formed along a peripheral rim at the top of the central column 26, proximate to the connection to the top section 22, so that waste fluid can flow from the fluid passage within the central column 26 and into the top section 22. Similarly, the central column 26 can also include apertures 30c formed along a peripheral rim at the bottom of the central column 26, proximate to the connection to the bottom section 24, so that waste fluid can flow from the fluid passage within the central column 26 and into the bottom section 24.

As shown in FIGS. 1 and 3A, and 3B, the top and bottom sections 22, 24 each include respective side walls 32, 34, which include top section side walls 32 and bottom section side walls 34. The side walls 32, 34 each extend away from the respective perimeters of the top and bottom sections 22, 24 to rest against the respective top and bottom surfaces 12a, 12b of the receptacle 12. Each of the side walls 32, 34 define a fluid volume within the top and bottom sections 22, 24 that are connected to the flow channel of the central column 26. The top section 22 includes apertures 30d formed on its surface and the bottom section 24 also includes apertures 30e formed on its surface. In this matter, the apertures 30d, 30e connect the fluid volumes within the top and bottom sections 22, 24 and the flow channel of the central column 26 to be connected to the interior volume 14 of the receptacle 12 as part of the fluid connection. Also, apertures 30f. 30g are respectively formed along the side walls 32, 34 of the top and bottom sections 22, 24, as part of the fluid connection. In this manner, waste fluid can circulate freely between the fluid volumes, the flow channel and the interior volume 14.

As shown in FIGS. 3A and 3B, the top and bottom sections 22, 24 each include respective sockets 36a, 36b which are shaped to receive and retain the central column 26 in a snug, interference fit. The sockets 36a, 36b can be cylindrical in order to matingly receive a cylindrical central column 26. However, the central column 26 can alternatively have a polyhedral cross-sectional profile, such as a square or other polyhedral, with a corresponding mating shape of the respective sockets 36a, 36b, without departing from the invention.

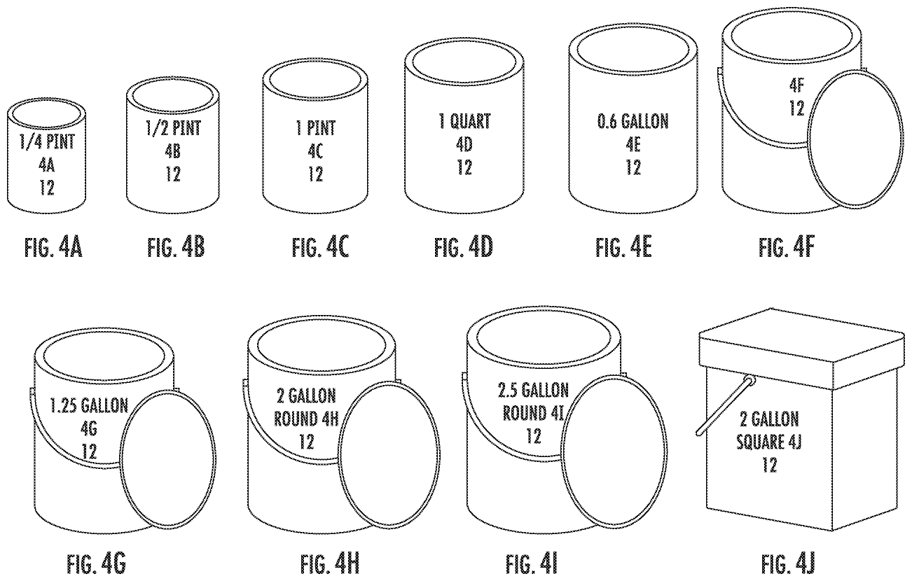

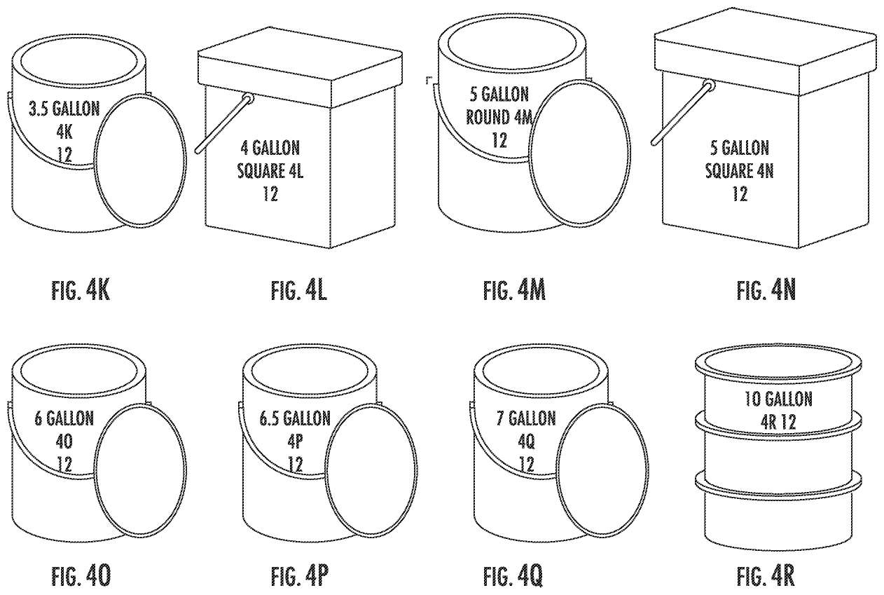

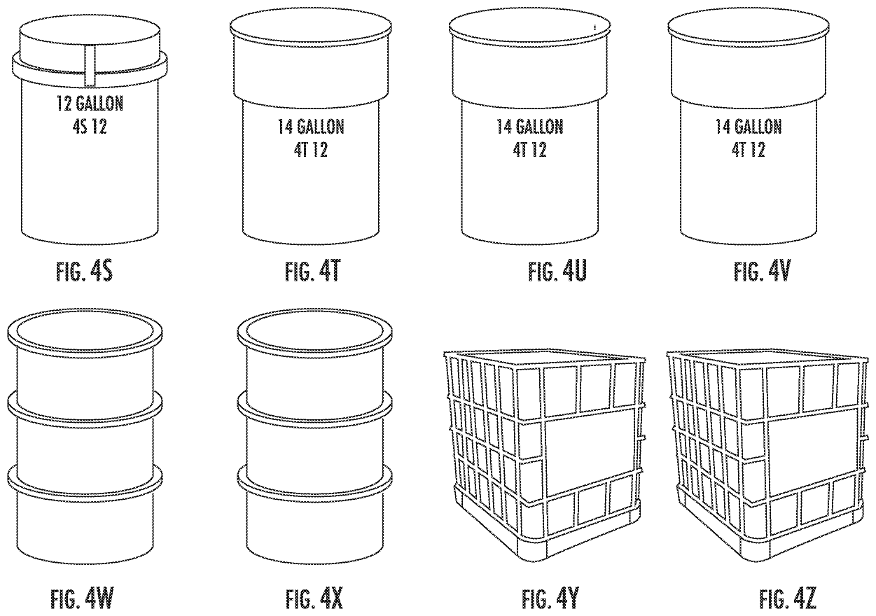

As shown in FIG. 1, the present waste management system 10 is configured such that the receptacle 12 has a cylindrical shape and the diffuser unit 20 is suitably configured to be received within the interior volume 14. As particularly shown in FIGS. 4A, 4B, 4C, 4D, 4E, 4F. 4G, 4H, 4I, 4J, 4K, 4L, 4M, 4N, 4O, 4P, 4Q, 4R, 4S, 4T, 4U, 4V, 4W (poly or steel), 4X (poly or steel), 4Y, and 4Z, the receptacle 12 can be respectively depict ¼ pint, ½ pint, 1 pint, 1 quart, 0.6 gallon, 1 gallon, 1.25 gallon, 2 gallon round, 2.5 gallon round, 2 gallon square, 3.5 gallon, 4 gallon square, 5 gallon round, 5 gallon square, 6 gallon, 6.5 gallon, 7 gallon, 10 gallon, 12 gallon, 14 gallon, 15 gallon, 16 gallon, 30 gallon or 55 gallon. The receptacle 12 can be an existing “off the shelf” container or can be formed of a specialty material. Alternatively, the receptacle 12 can be formed of a rectangular shape as with the 275 gallon receptacle 12 shown in FIG. 4G. In a cylindrical embodiment, the top and bottom sections 22, 24 each have a circular perimeter that fits within the cylindrical shape of the receptacle 12. The diameter of the circular perimeters of the top and bottom sections 22, 24, can be less than the diameter of the receptacle 12 at the top and bottom surfaces 12a, 12b within the interior volume 14. Alternatively, for a receptacle 12 having a rectangular shape, the top and bottom sections 22, 24 can suitably have a corresponding rectangular shape. As indicated hereinabove, certain receptacles can be formed of either poly or steel, or any other suitable material.

As particularly shown in FIG. 1, one or more solidification components 40 are retained within the interior volume 14 of the receptacle 12. The solidification component(s) 40 are selected to absorb and neutralize one or more components of the waste liquid into a chemically stable solid that can be safely disposed without contaminating the soil or water. Oil and organic based chemicals require primarily hydrophobic mediums for solidification, for example, sphagnum peat moss, coconut husks, cellulose byproducts from paper manufacturing, and/or sanitary manufacturing industries, used alone or together in combination. Kitchen grease can be solidified using corn cobb polyacrylamide and/or sodium polyacrylate, used alone or together in combination. Solvent based paints can be solidified using pinewood, sphagnum peat moss, coconut husks, and/or sodium polyacrylate, used alone or together in combination. Latex water based paints can be solidified using pinewood, cellulose byproducts from paper manufacturing, and/or sanitary manufacturing industries, used alone or together in combination.

In the present waste management system 10, the diffuser unit 20 can be formed of a material chemically compatible to the solidification component(s) 40. In one aspect, the diffuser unit 20 and the solidification component(s) 40 are both formed of a combustible material. In this manner, the solidified waste, along with the receptacle 12 and the diffuser unit 20, can be disposed by burning, as explained herein below. In another aspect, a plurality of solidification components 40 can be added to the receptacle 40 corresponding to a respective plurality of components of the waste liquid, to produce solidification and safe disposal for all the various components in the waste liquid.

A waste management process can be contemplated herewith. A receptacle is provided having an interior volume for receiving waste liquid, into which a diffuser unit is inserted and retained, where the diffuser unit is configured as described in the apparatus herein above. One or more solidification components are selected to absorb and neutralize one or more respective components of the waste liquid into a chemically stable solid. The solidification component(s) are added to the interior volume of the receptacle. The waste liquid is flowed into the fluid channel and through a fluid connection established between the fluid channel of the diffuser and the interior volume of the receptacle through apertures formed along surfaces of the diffuser unit so that the waste liquid is absorbed and neutralized into the chemically stable solid by the solidification component(s).

The present waste management process enables a variety of environmentally friendly disposal options. In one aspect, the process can include shredding the receptacle, the diffuser unit, and the chemically stable solid into a disposable material, which can be subsequently dumped without contaminating soil or water. The receptacle and the diffuser unit can be made of a biodegradable material that would break down in the ground. In an embodiment where the receptacle, the diffuser unit and the chemically stable solid are made of combustible materials, a process step can be performed of burning the receptacle, the diffuser unit, and the chemically stable solid in a combustion process. In another aspect, the combustible product can be used in a “mail back” program where the receptacle, the diffuser unit, and the chemically stable solid can be shipped to a receiver location for subsequent disposal by a recipient. Further, the recipient can in turn sell the combustible product to a third party who can use it as a fuel product. In other alternative aspects of the present waste management process, one or more additives can be added to the solidification component(s) to render the chemically stable solid into a soil suitable for growing a plant product. In this manner, the receptacle can become a planter for plants or trees.

In other aspects of the present invention, it is contemplated that the present waste management system and process would be primarily for the use in HHW (household hazardous waste) and/or in collaboration with retail locations (i.e., for disposal at auto supply or landscape supply DIY companies, hardware stores, paint companies and supply companies) along with waste disposal landfill companies (i.e., waste management, Republic Waste, waste connections, miscellaneous public landfills, etc.). The present waste management system with the diffuser unit as used in collaboration with local landfills would promote the safe and practical “solidification technology” by way of “pouring liquids (oils, paints, grease etc.) directly into the diffuser. The diffuser will “dry up” the waste in question where each particular waste stream has its own formulation for rendering the waste chemically inert. Afterwards, the solidified product can be simply placed into the normal trash as a “solid waste,” thereby alleviating the issues with “garbage juice” liquids leaking out of the back of the garbage trucks and into the soil and water.

In other aspects of the present invention, the present diffuser unit can be constructed by any manufacturing method (i.e., liquid injection molding, 3D printing, or any other suitable manufacturing methods using plastic, ABS and any other suitable materials for temporary use and or continued or permanent use) inserted into another container for the purpose of solidifying or drying a liquid household hazardous waste and or industrial and manufacturing waste. A diffuser unit for solidifying materials can be sold at retail locations for the purpose of solidifying household hazardous wastes included but not limited to gas, diesel, grease, oil, glycol, latex paint, solvent-based paint and any other household hazardous waste. “Garbage juice” liquids by way of transporting MSW (municipal solid waste) over the road from residential receptacles (i.e., garbage cans).

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A waste management system, comprising:
a receptacle having an interior volume for receiving waste liquid;
a diffuser unit configured to be inserted and retained within the interior volume of the receptacle;
a top section of the diffuser unit received and retained proximate to a top surface of the interior volume of the receptacle;
a bottom section of the diffuser unit received and retained proximate to a bottom surface of the interior volume of the receptacle;
a central column of the diffuser unit spanning the interior volume of the receptacle and defining a fluid channel between the top section and bottom section of the diffuser unit;
a plurality of apertures formed along at least one surface of at least one of the top section, the bottom section, and the central column, for establishing a fluid connection between the fluid channel and the interior volume of the receptacle for the waste liquid to flow; and
at least one solidification component retained within the interior volume of the receptacle, wherein the at least one solidification component is selected to absorb and neutralize at least one component of the waste liquid into a chemically stable solid.

2. The waste management system of claim 1, wherein the receptacle has a cylindrical shape and wherein the top and bottom sections each have a circular perimeter that fits within the cylindrical shape of the receptacle.

3. The waste management system of claim 1, wherein the top and bottom sections comprise side walls extending away from the circular perimeter to respectively rest against the top and bottom surfaces to each define a fluid volume connected to the flow channel.

4. The waste management system of claim 3, wherein at least some of the plurality of apertures are formed onto the top and bottom sections as part of the fluid connection.

5. The waste management system of claim 3, wherein at least some of the plurality of apertures are formed along the side walls as part of the fluid connection.

6. The waste management system of claim 3, wherein at least some of the plurality of apertures are formed onto the central column as part of the fluid connection.

7. The waste management system of claim 1, wherein the diffuser unit is formed of a material chemically compatible to the at least one solidification component.

8. The waste management system of claim 7, wherein the diffuser unit and the at least one solidification component are both formed of a combustible material.

9. The waste management system of claim 1, wherein the at least one solidification component comprises a plurality of solidification components corresponding to a respective plurality of components of the waste liquid.

10. A waste management process, comprising:
providing a receptacle having an interior volume for receiving waste liquid;
inserting and retaining a diffuser unit within the interior volume of the receptacle, wherein the diffuser unit comprises a top section received and retained proximate to a top surface of the interior volume of the receptacle, a bottom section received and retained proximate to a bottom surface of the interior volume of the receptacle, and a central column spanning the interior volume of the receptacle and defining a fluid channel between the top section and bottom section;
selecting at least one solidification component to absorb and neutralize at least one component of the waste liquid into a chemically stable solid;
adding the at least one solidification component to the interior volume of the receptacle; and
flowing the waste liquid into the fluid channel and through a fluid connection established between the fluid channel and the interior volume of the receptacle through a plurality of apertures formed along at least one surface of at least one of the top section, the bottom section, and the central column so that the waste liquid is absorbed and neutralized into the chemically stable solid by the at least one solidification component.

11. The waste management process of claim 10, further comprising shredding the receptacle, the diffuser unit, and the chemically stable solid into a disposable material.

12. The waste management process of claim 10, wherein the receptacle, the diffuser unit and the chemically stable solid are of combustible materials, and further comprising a step of burning the receptacle, the diffuser unit, and the chemically stable solid in a combustion process.

13. The waste management process of claim 10, further comprising adding a plurality of solidification components to absorb and neutralize a corresponding respective plurality of components of the waste liquid.

14. The waste management process of claim 10, further comprising shipping the receptacle, the diffuser unit, and the chemically stable solid to a receiver location for subsequent disposal.

15. The waste management process of claim 10, further comprising adding at least one additive to the at least one solidification component to render the chemically stable solid into a soil suitable for growing a plant product.
